(19) United States
(12) Patent Application Publication
(10) Pub. No.: US 2014/0062132 A1
(43) Pub. Date: Mar. 6, 2014

(54) Impact Beam

(71) Applicant: Edward Schleichert, Munchen (DE)

(72) Inventor: Edward Schleichert, Munchen (DE)

(21) Appl. No.: 14/014,097

(22) Filed: Aug. 29, 2013

(30) Foreign Application Priority Data
Sep. 3, 2012 (DE) 10 2012 215 598.8

(51) Int. Cl. B60J 5/04

(52) U.S. Cl. CPC B60J 5/0443
USPC 296/187.12; 219/617

(57) ABSTRACT

An impact beam for a motor vehicle body, in particular a side impact beam for a side door of a motor vehicle body, which impact beam consists of a first profile having a three-dimensional structure and a second component that spatially closes the first profile is provided. The two components have overlapping surfaces that are used for welding, wherein welding is carried out by electromagnetic or pulse welding.

### CROSS REFERENCE TO RELATED APPLICATION

This U.S. Patent Application claims the benefit of DE Patent Application Serial No. 10 2012 215598.8 filed Sep. 3, 2012, entitled “Impact Beam,” the entire disclosure of the application being considered part of the disclosure of this application, and hereby incorporated by reference.

### BACKGROUND OF THE INVENTION

1. Field of the Invention

The invention relates to an impact beam for a motor vehicle body, in particular a side impact beam for a side door of a motor vehicle body, the impact beam consisting of a first profile having a three-dimensional structure and a second component that spatially closes the first profile.

Impact beams of the kind in question are used in a motor vehicle body at different places. They can be found as bumper brackets, pillar reinforcements for A-pillar, B-pillar or C-pillars, as a cockpit crossmember or as a bumper crossmember, optionally connected to crash boxes. A particular field of use for the types of impact beams of the kind in question is as side doors of motor vehicles. There, such an impact beam is arranged as side impact protection in the region of the door body.

The present invention relates to impact beams for motor vehicle bodies in general. The exemplary embodiment of the invention is illustrated as side impact protection member for a side door of a motor vehicle body without being limited thereto. The impact beam of the exemplary embodiment is configured to provide effective protection to the interior of the motor vehicle body and to enable a connection to the associated structural components of the motor vehicle body.

2. Description of the Prior Art

It is already known to use a hollow profile member made of steel or aluminum as an impact beam for motor vehicle bodies, wherein based on a tube, the hollow profile member is designed as a one-piece steel profile of high strength, ductility and deformation energy, the end regions of which are formed in a lug-like manner for fastening to the structural component, in particular in the motor vehicle door (DE 41 33 144 B1). The tube can have a round or even an oval or an elliptical cross-section. Where applicable, two tubes can be arranged next to one another with regard to the direction of an impact to be expected. An impact beam for a motor vehicle body having two tube profiles arranged next to one another with regard to the direction of an impact to be expected has already been refined with regard to the manufacturing process in such a manner that both tube profiles consist of a one-piece strip steel that is brought into the desired cross-sectional shape by means of a roll forming method, wherein the strip steel that forms the tube profile is fixed at the joints by longitudinal welding seams (U.S. Pat. No. 6,591,577 B2).

Furthermore, it is known to produce the profiles not as closed tubes, but to form them in the shape of a hat using steel sheet, wherein structures having a double-hat shape are also possible. In order to generate higher stability and stiffness, the profiles are closed with a cover.

### SUMMARY OF THE INVENTION

The impact beam, as side impact protection made from aluminum, has flat portions at the ends for connecting in the profile component, from which flat portions then the one or the two parallelly extending hat profiles are generated. These profiles are shaped symmetrically and have an end face that extends along the longitudinal axis of the profile. The free longitudinal rims of the aluminum sheet and of the cover are arranged here overlapping each other and are connected by means of a longitudinal welding seam.

The teaching is based on the problem to configure and refine the known impact beam for a motor vehicle body, which impact beam is made from a strip-shaped aluminum sheet, in such a manner that a continuous force absorption as uniform as possible is ensured and that the production process runs in an optimized manner.

For closing the profile, the solution according to the invention uses electromagnetic pulse welding which, until now, has not been used for producing impact beams. One reason for this is that electromagnetic pulse welding could not be used until now because the required current has to be very high.

A great advantage is, in particular for a side impact beam as a safety-relevant element, that electromagnetic pulse welding is a cold joining method. During joining, no heat-affected zone is generated on the component, which heat-affected zone is a great disadvantage in the case of aluminum with regard to the strength of the material. Due to the cold joining method used for aluminum, electromagnetic pulse welding allows for the achievement of increased strength as compared to conventional thermal joining methods, thereby optimizing the safety-relevant behavior of the impact beam.

Advantageously, the impact beam is formed from two components that have surfaces that are welded together.

In one advantageous embodiment, one of the components forms a cover on the other component.

However, it is also advantageous to provide both components with a three-dimensional structure.

One embodiment exhibits a double-hat structure for an advantageous stiffness.

It is to be considered as an advantage that the lengths of the welding seams add up to a total length (L2) that corresponds at least to half the length of the profile (L1).

### BRIEF DESCRIPTION OF THE DRAWINGS

Advantageous embodiments of the invention are illustrated in more detail in the following figures and in the description.

FIG. 1 shows a view onto an exemplary impact beam.

FIG. 2 shows section through two embodiments.

FIG. 3 shows another embodiment.

### DESCRIPTION OF THE ENABLING EMBODIMENT

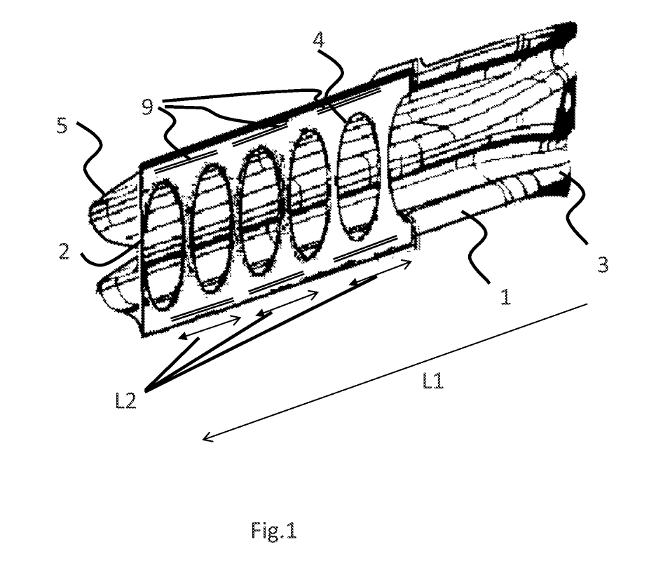

FIG. 1 shows an exemplary embodiment of an impact beam. A first profile 1 extends along the entire length L1 of the impact beam. On the right side of the drawing it is shown that the profile is flattened so as to form an end piece 3 and to simplify the installation. The profile forms a double W-shaped channel 5 that extends from the first end piece 3 to the second end piece which is not illustrated here. The profile 1 is covered by a second component 2 which has a plurality of recesses 4 in this embodiment. Both components are connected to one another at their edges via welding seams that extend with minor interruptions along the longitudinal axis of the profile and the cover and together result in a welding seam of the length L2 that represents at least half of the length L1, but advantageously more than ⅔ of the length L1.

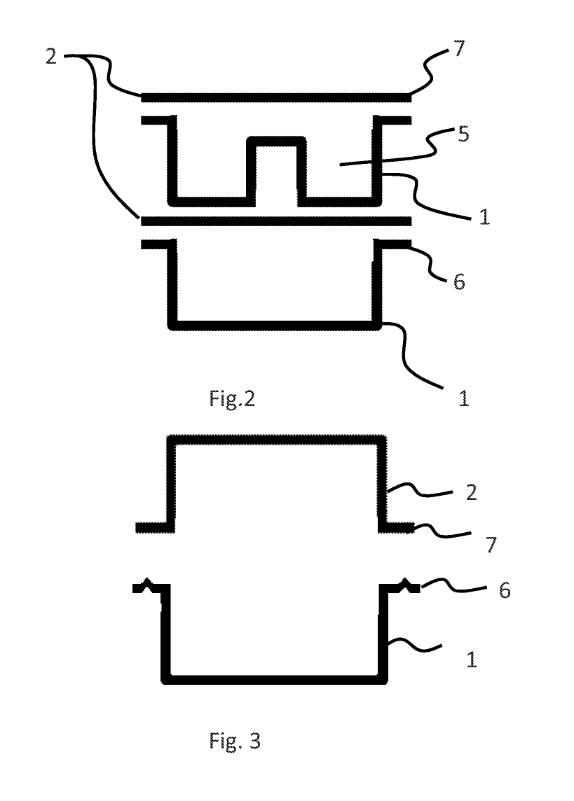

FIG. 2 shows cross-sections through two examples, wherein the profile 1 has a single or a double hat-shaped contour. The second component 2 is formed as a flat cover.

The profile 1 forms a first welding surface 6 that faces a second welding surface 7 that is formed by the cover.

For closing the profile, the solution according to the invention uses an electromagnetic pulse (EMP) welding method. This EMP welding is able, without heat and by means of the magnetic metal forming method, to bond dissimilar material joints but also similar material joints in a very short time, typically in approximately 25 μs. In the process of this, one of the joining partners is exposed without contact to a pulse by means of a magnetic field and bounces against the other partner. For this method, the components are located in the vicinity of a magnetic coil through which a very high current pulse flows. For at least one of the joining partners, only materials with good conductivity, such as aluminum, can be processed. Due to the high speed of the collision of the joining partners, similar to explosion welding, adhesive bonding in the solid phase takes place. When connecting sheet metal, the magnetic pulse of one of the two sheets to be joined accelerates over a distance of 0.3-2 mm to speeds exceeding 200 m/s. During the impact of this sheet against a stationary counter sheet, the oxide layers adhering in the impact area on both surfaces are detached and the air between the sheets is blown out. The pure surfaces generated in this manner are now highly reactive and are pressed against each other with high pressure. This results in a metallic bond due to an exchange of electrons. This method introduces hardly any heat into the components. Thus, it is possible to weld metallic material with very different melting points. Moreover, the microstructure is not affected by the influence of heat. It is therefore possible, for example, to establish connections between sheets made of aluminum alloys and sheets of high-strength steels without changing their respective strength-determining microstructures.

During welding of sheet metal of a thickness between 1 and 2.5 mm, very high current densities are necessary. The capacitor has to supply current of up to 1 million amps in order to be able to join sheets of this thickness together.

FIG. 3 shows an embodiment in which both components to be welded together are formed as three-dimensional components in order to produce an impact beam with optimized properties. Here, advantageously, a cover is conceivable that is provided with stiffening ribs along its longitudinal axis and thereby is given a three-dimensional formation.

With the proposed electromagnetic pulse welding method, the impact beams can be produced significantly faster and more cost-effectively.

1. An impact beam for motor vehicle body, in particular a side impact beam for a side door of a motor vehicle body, the impact beam consisting of a first profile having a three-dimensional structure, and a second component that spatially closes the first profile, wherein the two components have overlapping surfaces that are joined together through welding, and wherein the welding is electromagnetic pulse welding.

2. The impact beam according to claim 1, wherein the second component is formed as an almost flat cover.

3. The impact beam according to claim 1, wherein the second component also has a three-dimensional structure.

4. The impact beam according to claim 1, wherein at least one of the components has a double-hat structure.

5. The impact beam according to claim 1, wherein at least one component is made of aluminum.

6. The impact beam according to claim 1, wherein the lengths of the welding seams add up to a total length that corresponds at least to half the length of the profile.

7. The impact beam according to claim 1, wherein the lengths of the welding seams are between 50 and 100 mm.

8. The impact carrier according to claim 1, wherein the components to be connected have thicknesses of from 1 to 2.5 mm.

9. A method for producing impact beams for a motor vehicle body, in particular a side impact beam for a side door of a motor vehicle body, the impact beam consisting of a first profile having a three-dimensional structure, and a second component that spatially closes the first profile, wherein the two components have overlapping surfaces that are used for welding, wherein the overlaying surfaces are welded together with electromagnetic pulse welding.
